(19) United States
(12) Patent Application Publication
(10) Pub. No.: US 2021/0268672 A1
(43) Pub. Date: Sep. 2, 2021

(54) MULTIFUNCTIONAL UTILITY KNIFE

(71) Applicant: Hong Ann Tool Industries Co., Ltd., Taichung City (TW)

(72) Inventor: Cheng-Wei SU, Taichung City (TW)

(21) Appl. No.: 17/325,609

(22) Filed: May 20, 2021

Related U.S. Application Data
(63) Continuation-in-part of application No. 16/665,247, filed on Oct. 28, 2019.

(30) Foreign Application Priority Data
Feb. 1, 2019 (TW) 108104318

(51) Int. Cl. B26B 9/02; B26B 3/00

(52) U.S. Cl. CPC B26B 9/02; B26B 3/00

(57) ABSTRACT

A multifunctional utility knife includes a body and a blade housed by the body. The body has an open end surface. The open end surface extends on a reference plane. The blade has a cutting edge including a first cutting edge portion and a second cutting edge portion configured for different cutting tasks. The blade in a use position includes the first and the second cutting edge portions disposed outside the body. The first cutting edge portion extends arcuately. The second cutting edge portion extends linearly along a reference line which intersects with the reference plane.

### CROSS REFERENCE

This application is a continuation-in-part of Ser. No. 16/665,247, filed Oct. 28, 2019, now abandoned, which is hereby incorporated by reference in its entirety.

### BACK EDGEGROUND OF THE INVENTION

### 1. Field of the Invention

The present invention relates to a multifunctional utility knife.

### 2. Description of the Related Art

TW Pat. No. M415789 shows a strap knife. The strap knife includes a first cutter at a first end for cutting a packaging tape and a second cutter at a second end for cutting a packaging strap. The strap knife also includes a two guiding slopes adjacent to the second cutter. The two guiding slopes have a common end and diverge along a longitudinal direction of the strap knife.

The strap knife can save a user the trouble of using one knife for cutting a packaging tape and another knife for cutting a strap. It is, however, inconvenient for the user to operate two cutters.

The present invention is, therefore, intended to obviate or at least alleviate the problems encountered in the prior art.

### SUMMARY OF THE INVENTION

According to the present invention, a multifunctional utility knife includes a body. The body has an open end surface. The open end surface extends on a reference plane. The multifunctional utility knife also includes a blade housed by the body. The blade extends through the open end surface when exposed. The blade has a cutting edge including a first cutting edge portion and a second cutting edge portion configured for performing different cutting tasks. The blade in a use position includes the first and the second cutting edge portions disposed outside the body. The first cutting edge portion extends arcuately from a first end to a second end. The second cutting edge portion extends linearly from a first end to a second end along a first reference line which intersects with the reference plane. The first end of first cutting edge portion is adjacent to the second cutting edge portion.

Further, tangents to the first cutting edge portion including a first tangent at the first end thereof, a second tangent at a maximum turning point thereof, and a third tangent at a medium between the first end and the maximum turning point thereof. The first and the third tangents slope up from left to right. The second tangent is horizontal. The first tangent intersects with the reference plane and a first included angle defined therebetween is less than 90 degrees.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a multifunctional utility knife in accordance with the present invention.

FIG. 2 is a side view of the multifunctional utility knife.

FIG. 3 is a side view illustrating the multifunctional utility knife including a first portion of a blade cutting a strap, with the cutting direction indicated by an arrow.

FIG. 4 is a side view illustrating the multifunctional utility knife including a second portion of the blade cutting a tape, with the cutting direction indicated by an arrow.

FIG. 5 is a partial, enlarged side view of the multifunctional utility knife.

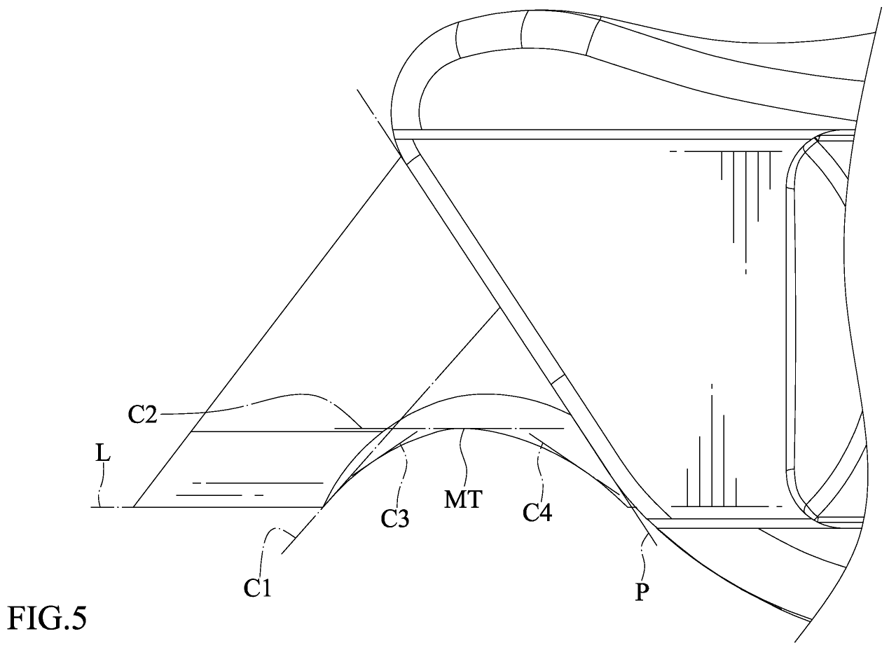

### DETAILED DESCRIPTION OF THE INVENTION

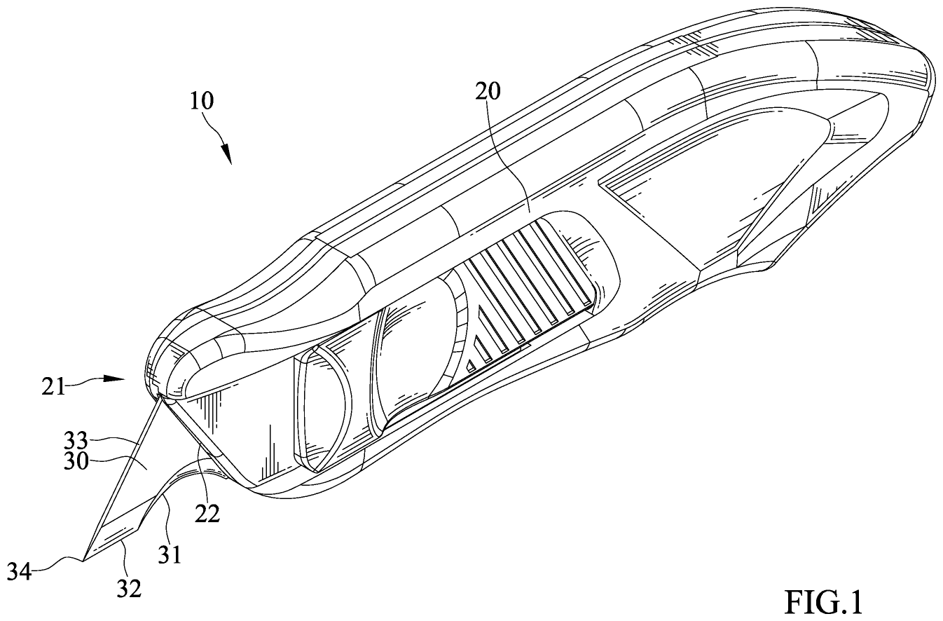

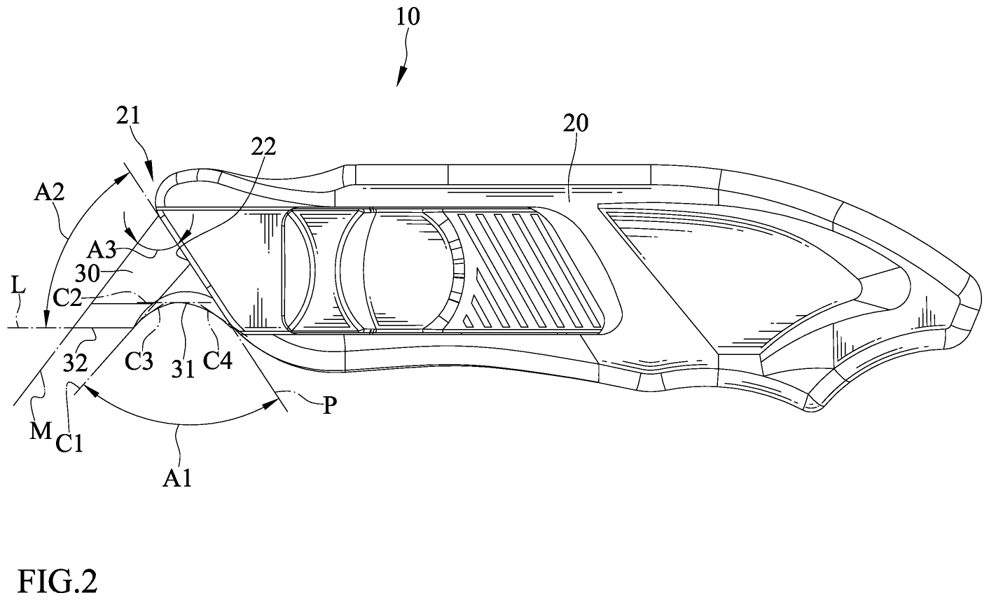

FIGS. 1 through 4 show a multifunctional utility knife 10 in accordance with the present invention.

The multifunctional utility knife 10 includes a body 20. The body 20 can serve as a handle adapted to be gripped when using the multifunctional utility knife 10. The open end surface 22 extends on a reference plane P. The open end surface 22 is at a front end 21 of the main body 20.

The multifunctional utility knife 10 includes a blade 30 housed by the body 20. The blade 30 has a cutting edge including a first cutting edge portion 31 and a second cutting edge portion 32 configured for performing different cutting tasks. The blade 30 in a use position includes the first and the second cutting edge portions 31 and 32 disposed outside the body 20. The cutting edge of the blade 30 includes the first cutting edge portion 31 of a first length and the second cutting edge portion 32 of a second length respectively. The first length is greater than the second length.

The first cutting edge portion 31 extends arcuately from a first end to a second end and is concave. Tangents to the first cutting edge portion 31 including a first tangent C1 at the first end thereof, a second tangent C2 at a maximum turning point MT thereof, a third tangent C3 at a medium between the first end and the maximum turning point MT thereof, and a fourth tangent C4 at a medium between the maximum turning point MT and the second end thereof. The first and the third tangents C1 and C3 slope up from left to right. The first and the third tangents C1 and C3 have positive gradient. The first tangent C1 intersects with the reference plane P and a first included angle A1 defined therebetween is less than 90 degrees. The first included angle A1 is greater than 55 degrees and less than 85 degrees. In a preferred embodiment, the first included angle A1 is 75 degrees. The second tangent C2 is horizontal. The second tangent C2 is parallel to the reference line L. The second tangent C2 has zero gradient. The fourth tangent C4 slopes down from left to right. The fourth gradient has negative gradient.

The second cutting edge portion 32 extends linearly from a first end to a second end along a first reference line L which intersects with the reference plane P. The first reference line L intersects with the reference plane P and a second included angle A2 therebetween is less than 90 degrees. In a preferred embodiment, the second included angle A2 is 57 degrees.

Further, the first cutting edge portion 31 extends from the second end of the second cutting edge portion 32. The first cutting edge portion 31, along a horizontal direction, as it extends from the first to the second ends thereof, is further away from the second cutting edge portion 32.

The blade 30 also has a back edge 33 disposed outside the body 20 when the blade 30 in the use position. The back edge 33 is inclined to the second cutting edge portion 32. The back edge 33 extends on a second reference line M. The second reference line M intersects with the reference plane P and a third included angle A3 therebetween is not greater than 90 degrees. Moreover, the blade 30 has a tip 34 disposed outside the body 20 when the blade 30 is in the use position. The back edge 33 and the second cutting edge portion 32 are converged at the tip 34.

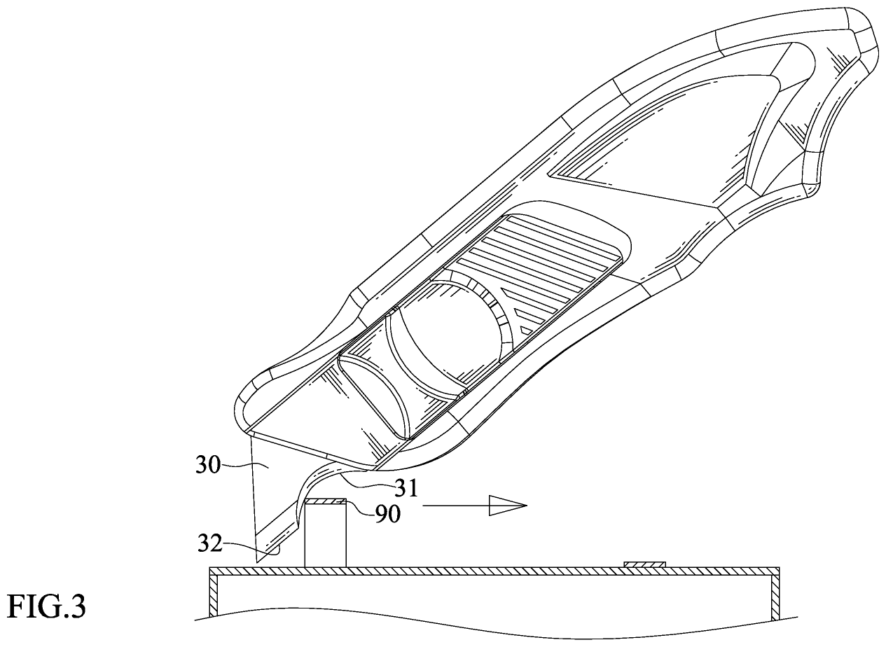

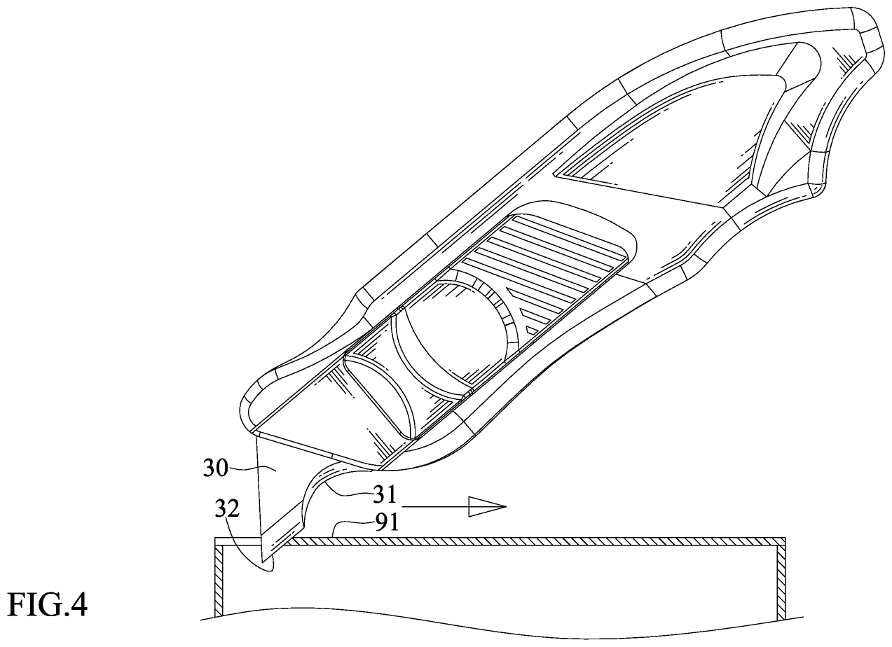

FIG. 3 shows cutting a strap 90 with the cutting edge portion 31. FIG. 4 shows inserting the tip of the blade 30 through a tape 91 and then cutting the tape 91 with the cutting edge portion 32.

In view of the foregoing, the strap 90 can be cut with the cutting edge portion 31 of the blade 30, and the tape 91 can be cut with the cutting edge portion 32 of the blade 30. Therefore, the blade 30 of the multifunctional utility knife 10 eases the user's burden to cut the strap 90 and the tape 91 as described in the Description of the Related Art.

The foregoing is merely illustrative of the principles of this invention and various modifications can be made by those skilled in the art without departing from the scope and spirit of the invention.

What is claimed is:

1. A multifunctional utility knife comprising:
a body, wherein the body has an open end surface, and wherein the open end surface extends on a reference plane;
a blade housed by the body, wherein the blade extends through the open end surface when exposed, wherein the blade has a cutting edge including a first cutting edge portion and a second cutting edge portion configured for performing different cutting tasks, wherein the blade in a use position includes the first and the second cutting edge portions disposed outside the body, wherein the first cutting edge portion extends arcuately from a first end to a second end, wherein the second cutting edge portion extends linearly from a first end to a second end along a first reference line which intersects with the reference plane, wherein the first end of first cutting edge portion is adjacent to the second cutting edge portion; and
tangents to the first cutting edge portion including a first tangent at the first end thereof, a second tangent at a maximum turning point thereof, and a third tangent at a medium between the first end and the maximum turning point thereof, wherein the first and the third tangents slope up from left to right, wherein the second tangent is horizontal, and wherein the first tangent intersects with the reference plane and a first included angle defined therebetween is less than 90 degrees.

2. The multifunctional utility knife as claimed in claim 1, wherein the tangents to the first cutting edge portion include a fourth tangent at a medium between the maximum turning point and the second end thereof, and wherein the fourth tangent slopes down from left to right.

3. The multifunctional utility knife as claimed in claim 1, wherein the first included angle is greater than 55 degrees and less than 85 degrees.

4. The multifunctional utility knife as claimed in claim 3, wherein the first reference line intersects with the reference plane and a second included angle therebetween is less than 90 degrees.

5. The multifunctional utility knife as claimed in claim 3, wherein the first included angle is 75 degrees.

6. The multifunctional utility knife as claimed in claim 4, wherein the first included angle is 75 degrees, and wherein the second included angle is 57 degrees.

7. The multifunctional utility knife as claimed in claim 2, wherein first included angle is greater than 55 degrees and less than 85 degrees, and wherein the second included angle is greater than 40 degrees and less than 75 degrees.

8. The multifunctional utility knife as claimed in claim 5, wherein the first included angle is 75 degrees, and wherein the second included angle is 57 degrees.

9. The multifunctional utility knife as claimed in claim 1, wherein the first cutting edge portion extends from the second end of the second cutting edge portion.

10. The multifunctional utility knife as claimed in claim 1, wherein the blade has a back edge disposed outside the body when the blade is in the use position, and wherein the back edge is inclined to the second cutting edge portion.

11. The multifunctional utility knife as claimed in claim 10, wherein the blade has a tip disposed outside the body when the blade is in the use position, wherein the back edge and the second cutting edge portion are converged at the tip.

12. The multifunctional utility knife as claimed in claim 10, wherein the back edge extends on a second reference line, and wherein the second reference line intersects with the reference plane and a third included angle therebetween is not greater than 90 degrees.

13. The multifunctional utility knife as claimed in claim 1, wherein the cutting edge of the blade includes the first cutting edge portion of a first length and the second cutting edge portion of a second length respectively, and wherein the first length is greater than the second length.

14. The multifunctional utility knife as claimed in claim 2, wherein the cutting edge of the blade includes the first cutting edge portion of a first length and the second cutting edge portion of a second length respectively, and wherein the first length is greater than the second length.

15. The multifunctional utility knife as claimed in claim 7, wherein the blade has a back edge disposed outside the body when the blade is in the use position, and wherein the back edge is inclined to the second cutting edge portion.

16. The multifunctional utility knife as claimed in claim 15, wherein the blade has a tip disposed outside the body when the blade is in the use position, wherein the back edge and the second cutting edge portion are converged at the tip.

17. The multifunctional utility knife as claimed in claim 16, wherein the back edge extends on a second reference line, and wherein the second reference line intersects with the reference plane and a third included angle therebetween is not greater than 90 degrees.

18. The multifunctional utility knife as claimed in claim 17, wherein the cutting edge of the blade includes the first cutting edge portion of a first length and the second cutting edge portion of a second length respectively, and wherein the first length is greater than the second length.

19. The multifunctional utility knife as claimed in claim 1, wherein the first cutting edge portion, along a horizontal direction, as it extends from the first to the second ends thereof, is further away from the second cutting edge portion.
